(19) United States
(12) Patent Application Publication
(10) Pub. No.: US 2003/0090445 A1
(43) Pub. Date: May 15, 2003

(54) Current driver for active matrix organic light emitting diode

(75) Inventors: Chien-Chih Chen, Shinying City (TW); Shang-Li Chen, Hsinchu (TW)

Correspondence Address: BACON & THOMAS, PLLC, 625 SLATERS LANE, FOURTH FLOOR, ALEXANDRIA, VA, 22314

(73) Assignee: Industrial Technology Research Institute, Hsin-Chu Hsien (TW)

(21) Appl. No.: 10/173,153

(22) Filed: Jun. 18, 2002

(30) Foreign Application Priority Data
Nov. 14, 2001 (TW) 090128163

(51) Int. Cl. G09G 3/30

(52) U.S. Cl. 345/76; 345/80; 345/82; 345/98

(57) ABSTRACT

The present invention provides an integrated current driver structure for an active matrix organic light emitting diode, in which a current driver alternately inputs current from a main current source to a plurality of data lines, thereby reducing the current consumption and the number of ICs.

### FIELD OF THE INVENTION

The invention relates to a current driver for an active matrix organic light emitting diode (OLED).

### BACKGROUND OF THE INVENTION

Presently, conventional cathode ray tube (CRT) display devices no longer satisfy the demands of display device market. New generations of display devices must satisfy the demands of lightweight, compactness, low power consumption, and high display quality. OLED have the advantages of self-luminescence, high response speed, wide view angle range, superior resolution and high brightness, and represent therefore a future important technologic trend still in development. Most OLED devices are conventionally current-driven in “passive fashion”. The higher the resolution, the more current is required. An active matrix OLED has been proposed to fabricate an OLED with high resolution. The active matrix OLED is fabricated via several conventional processes such as low temperature polycrystalline silicon (LTPS) thin film transistor (TFT) process, while the LTPS TFT operates as an active device.

However, because the uniformity of the LTPS TFT is poor, many approaches have been proposed to reduce the negative effect of nonuniformity on the characteristics of the device. As shown in FIG. 1, in a conventional current driver used in an active matrix OLED, a scan driver typically controls the programming and reproducing time. Each data line requires a current input. Consequently, the higher the resolution, the more the current input pins are required.

### SUMMARY OF THE INVENTION

A principal object of the invention is therefore to solve the above-mentioned issues.

Another object of the invention is to provide an integrated current driver structure for an active matrix OLED in which the number of external leads and the power consumption of the system, and the packaging cost are reduced.

In order to achieve the above and other objectives, the to invention provides an integrated current driver structure for an active matrix OLED in which a current driver, connecting a driving Integrated circuit (IC) to an active pixel matrix, alternately inputs a current to a plurality of data lines. Thereby, the current input, the number of driving ICs, and the power consumption of the system can be reduced if the time of discharging/charging each data line or pixels is short enough. If two sets of current drivers are used, then the discharging/charging time of the data lines or pixels can be maintained equal to the processing time of a row of pixels.

### BRIEF DESCRIPTION OF THE DRAWINGS

The drawings included herein provide a further understanding of the invention and, incorporated herein, constitute a part of the invention disclosure. A brief introduction of the drawings is as follows:

FIG. 1 is a schematic view of a conventional current driver.

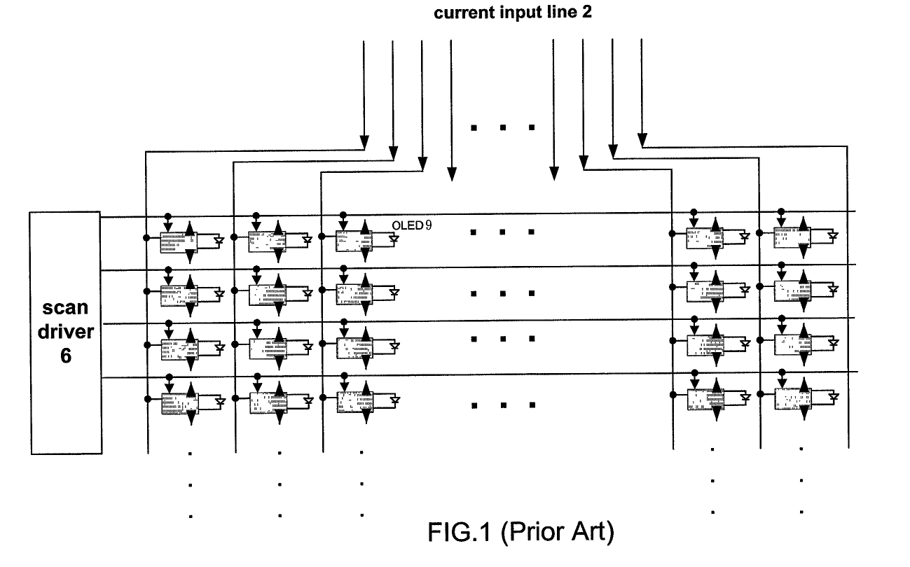

FIG. 2 is a schematic view of an integrated current driver structure for an active matrix OLED according to a first embodiment of the invention.

FIG. 3 is a schematic view of an integrated current driver structure for an active matrix OLED according to a second embodiment of the invention.

FIG. 4 is a first timing chart of the current driver structure according to the first embodiment of the invention.

FIG. 5 is a second timing chart of the current driver structure according to the first embodiment of the invention.

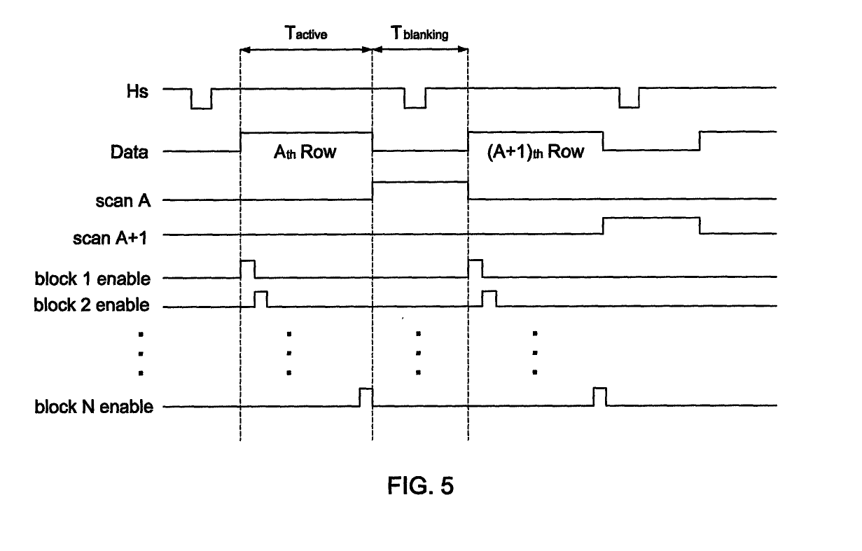

FIG. 6 is a timing chart of the current driver structure according to the second embodiment of the invention.

### DESCRIPTION OF THE PREFERRED EMBODIMENTS

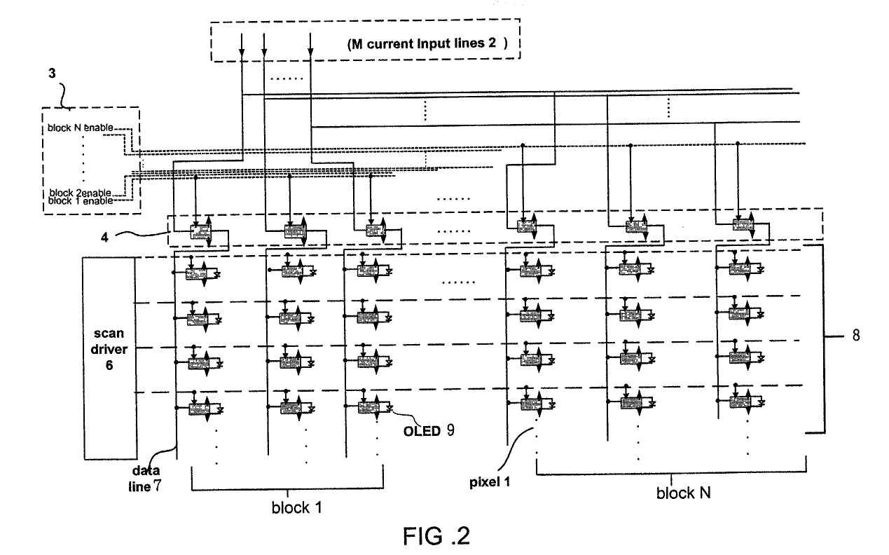

FIG. 2 is schematic view of an integrated current driver structure for an active matrix OLED according to a first embodiment of the invention. As shown in FIG. 2, a plurality of pixels 1 is arranged in matrix on a panel to form an active pixel matrix 8. Each of the pixels 1 has an OLED 9. The brightness of the OLED 9 in each of the pixels 1 is controlled via a current inputted from a plurality of current input lines 2. Each of the current input lines 2 is connected to an input port of a first current driver 4. The first current driver 4 consists of a plurality of driver units arranged in a row on the panel, with each of the driver units corresponding to a column of pixels 1. Each driver unit is connected to one current input line 2 and a column of the pixels 1 via a data line 7. A plurality of current controllers 3 control data refreshing sequence of the current driver 4.

Refreshing of a display data of each pixel 1 can be controlled via a scan driver 6. The pixels in one row are connected to the same scan line. A data line 7 provides each pixel 1 in one column with the corresponding brightness data. The pixels of one column are connected to the same data line 7. When a control signal to a current driver 4 consists of a plurality of driver units arranged in a row on the panel, with each of the driver units corresponding to a column of pixels 1. Each driver unit is connected to one current input line 2 and a column of the pixels 1 via a data line 7. A plurality of current controllers 3 control data refreshing sequence of the current driver 4.

Refreshing of a display data of each pixel 1 can be controlled via a scan driver 6. The pixels in one row are connected to the same scan line. A data line 7 provides each pixel 1 in one column with the corresponding brightness data. The pixels of one column are connected to the same data line 7. When a control signal to a driver unit of the current driver 4 is “ON”, a current input signal is sampled and sent to the corresponding output data line. When the control signal is “OFF”, the current is held. The current driver output may be slightly different to the input due to process variation or other issues. However, the size of the current driver, in contrast with the size of the pixel, is not constrained by the resolution. Therefore, the current driver is designed mainly based on the accuracy of the current control, with a secondary consideration of the size of the current driver.

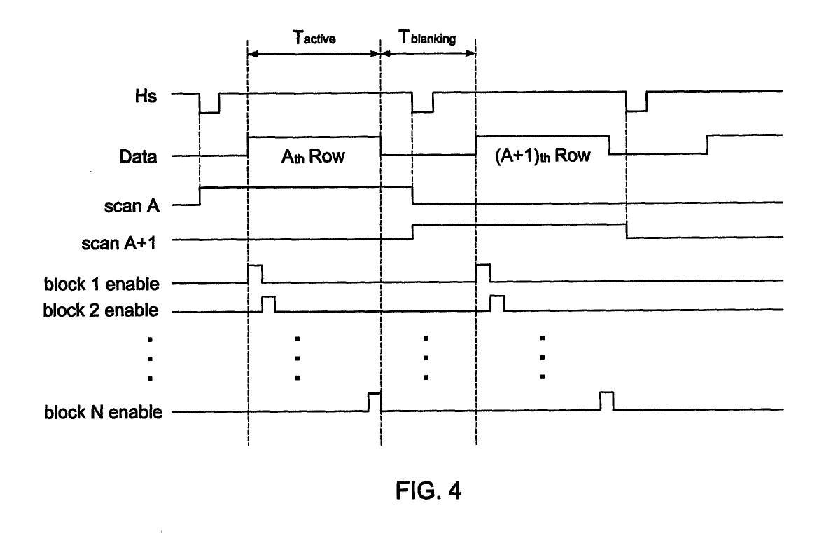

In FIG. 2, N data lines 7 are alternately driven by a current input line 2 through the driver units. Therefore, M current input lines 2 connected to the current driver 4 can achieve the programming of N×M data lines. The driver units and the corresponding column of pixels are divided into N blocks, each of which has M driver units. All the M driver units in the same block of current driver 4 are connected to one controller. Therefore the current is inputted into one of the N blocks at one time. Timing chart of the first preferred embodiment as FIG. 2 is shown in FIG. 4. In the period “T_{active}” while data is active, the driver units of each block have a time period of T_{active}/N to perform programming.

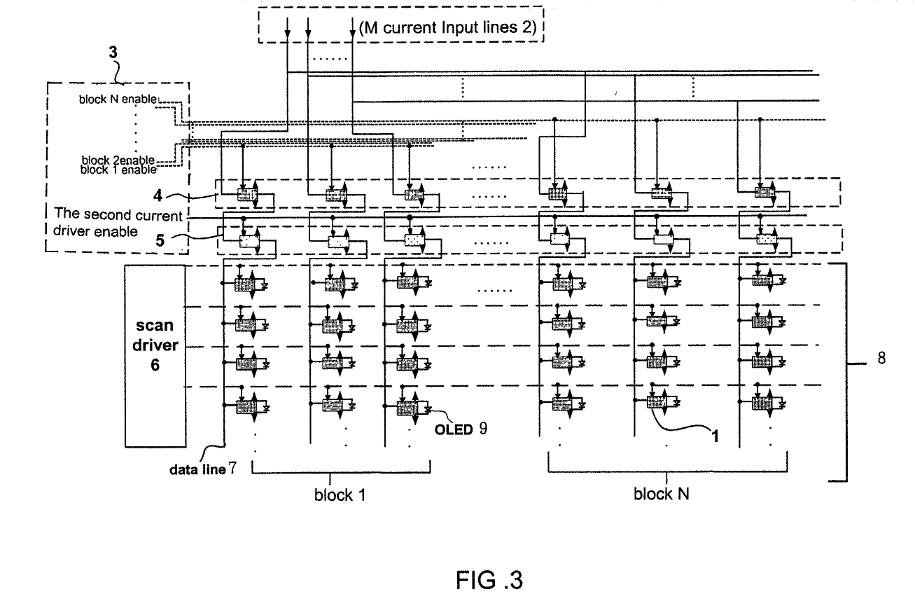

FIG. 3 is a schematic view of an integrated current driver structure for an active matrix OLED according to a second preferred embodiment of the invention. The first current driver 4 consists of a plurality of first driver units arranged in a first row on a panel. Each of the current input lines 2 is connected to an input port of one first driver unit. The second current driver 5 consists of a plurality of the second driver units arranged in a second row on the panel. Each of the first driver units connects a current input line 2 to one of the second driver unit, while each of the second driver unit connects one first driver unit to a column of pixels 1. Refreshing of current data of the first and second driver units is controlled by a plurality of current controllers 3. A scan driver 6 controls refreshing of the display data of each pixel 1. The pixels 1 in one row is connected to the same scan line. A data line 7 provides each pixel 1 with the corresponding brightness data. The pixels of one column are connected to the same data line 7.

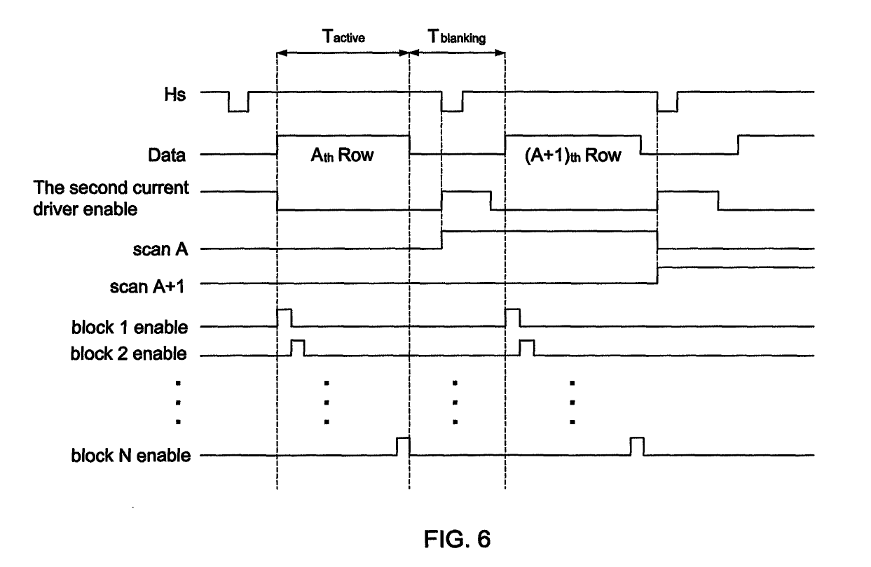

As the display resolution becomes higher, the scanning time of a row of data becomes shorter. The time T_{active}/N or T_{blank} as shown in the first embodiment of the invention may not be enough for programming of the pixels. Therefore, as shown in FIG. 3, the second current driver 5 can be further provided between the first current driver 4 and the active pixel matrix 8, with the current driver connecting an output port of the first current driver 4 to a column of pixels 1 via a data line 7. A control signal allows the second current driver 5 to sample a current that is required to process the whole row of pixels and outputted from the first current driver 4. When the data of one next row of pixels is sampled by the first current driver 4, the second current driver 5 has a charging time equal to the processing time of one whole row of pixels to charge the data line 7 and the pixels 1. Timing chart of the second preferred embodiment as FIG. 3 is shown in FIG. 6. Since the inputted current is sampled and held twice by the two current drivers 4 and 5, current error may be larger than the first preferred embodiment. Therefore, the current drivers should be designed more carefully to satisfy desired accuracy of the current control.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. An integrated current driver structure for an active matrix OLED, comprising:
a panel;
a pixel matrix consisting of a plurality of pixels arranged in matrix on the panel;
a current driver having a plurality of driver units arranged in a row on the panel, wherein an output of the driver unit is connected to a column of pixels by a data line;
a plurality of current controllers in charge of refreshing sequence of current data of the current driver;
a plurality of current input lines, each of which is connected to an input of one driver unit; and
a scan driver connected to the pixels in charge of refreshing sequence of current data of the pixels in a row. The scan driver may be integrated on the panel or impleamented outside the panel with driver ICs.

2. The structure of claim 1, wherein the active pixel matrix includes a plurality of pixels arranged in matrix on the panel, each of the pixels having an OLED or polymer-based light emitting diode or any other luminescence devices in which the brightness is controlled by current and the refresh of display data is controlled by a scan line.

3. The structure of claim 1, wherein the driver unit of the current driver samples the current from the input and regenerates a current in a predetermined ratio at it's output.

4. An integrated current driver structure of an active matrix OLED, comprising:
a panel;
a pixel matrix consisting of a plurality of pixels arranged in matrix on the panel;
a first current driver having a plurality of first driver units arranged in a first row on the panel;
a second current driver having a plurality of second driver units arranged in a second row on the panel;
a plurality of current controllers in charge of refreshing sequence of current data of the first and second current drivers;
a plurality of current input lines, each of which is connected to an input of one first driver unit, while an output of each first driver unit in the first row is connected to an input of each second driver unit in the second row, and an output of each second driver unit is connected to a column of pixels by a data line;
a scan driver connected to the pixels in charge of refreshing sequence of current data of the pixels in a row. The scan driver can be integrated on the panel or impleamented outside the panel with driver ICs.

5. The structure of claim 4, wherein the active pixel matrix include a plurality of pixels arranged in matrix on the panel, each of the pixels having an OLED or polymer-based light emitting diode or any other luminescence device in which the brightness is controlled by current and the refresh of display data is controlled by a scan line.

6. The structure of claim 4, wherein the driver unit of the first and second current drivers samples the current from the input and regenerates a current in a predetermined ratio at it's output, respectively.
